(19) United States
(12) Patent Application Publication
(10) Pub. No.: US 2014/0118252 A1
(43) Pub. Date: May 1, 2014

(54) METHOD OF DISPLAYING CURSOR AND SYSTEM PERFORMING CURSOR DISPLAY METHOD

(71) Applicants: MIN HO KIM, SEONGNAM-SI (KR); DONG WOOK KWON, SUWON-SI (KR); KYUNG IL KIM, ANYANG-SI (KR); GI SANG LEE, SUWON-SI (KR); SANG BO LEE, YONGIN-SI (KR); JIN KYUNG LEE, SUWON-SI (KR); YOUNG GU JIN, OSAN-SI (KR); JIN WUK CHOI, SEOUL (KR)

(72) Inventors: MIN HO KIM, SEONGNAM-SI (KR); DONG WOOK KWON, SUWON-SI (KR); KYUNG IL KIM, ANYANG-SI (KR); GI SANG LEE, SUWON-SI (KR); SANG BO LEE, YONGIN-SI (KR); JIN KYUNG LEE, SUWON-SI (KR); YOUNG GU JIN, OSAN-SI (KR); JIN WUK CHOI, SEOUL (KR)

(21) Appl. No.: 14/062,043

(22) Filed: Oct. 24, 2013

(30) Foreign Application Priority Data
Oct. 25, 2012 (KR) 10-2012-0118985

(51) Int. Cl. G06F 3/01

(52) U.S. Cl. CPC G06F 3/017
USPC 345/157

(57) ABSTRACT

A cursor displaying method that re-sizes a cursor displayed in a display field while repositioning the cursor in response to a detected user gesture.

### CROSS-REFERENCE TO RELATED APPLICATIONS

This application claims the benefit of Korean Patent Application No. 10-2012-0118985 filed on Oct. 25, 2012, the subject matter of which is hereby incorporated by reference.

### BACKGROUND

The inventive concept relates generally to gesture recognition technology. More particularly, the inventive concept relate to methods of adaptively displaying a cursor on a display in response to one or more gestures, as well as system performing such methods.

Advances in display technology offer users of electronic devices a much richer experience. The images displayed by contemporary displays more realistic. Some displays provide images having 3-dimensional (3D) qualities and affects.

A “cursor” is a particular image that may be used to indicate a position or area within the display field of a display. Cursors have been used since the earliest computer programs, and are very useful feedback mechanism for a user visually engaged with the constituent display. Like other visual effects provided by contemporary displays, the control, definition and representation of one or more cursor(s) on a display can positively contribute to the overall user experience with a display.

### SUMMARY

According to an aspect of the inventive concept, there is provided a cursor displaying method comprising; displaying a cursor in a display field of a display, sensing a user gesture with a sensor, generating a sensing signal including gesture information derived from the sensed user gesture, and controlling the display in response to the sensing signal to re-size the cursor in the display field at least once along a cursor path defined by the gesture information while repositioning the cursor from an initial position to a final position in the display field.

According to an aspect of the inventive concept, there is provided a system comprising; a three-dimensional (3D) display that displays a cursor in a 3D display field, a sensor that senses a user gesture and provides a corresponding sensing signal, and a central processing unit (CPU) that controls the 3D display to re-size the cursor according to the sensing signal as the cursor is repositioned in the 3D display field in response to the user gesture.

### BRIEF DESCRIPTION OF THE DRAWINGS

Certain embodiments of the inventive concept will be described in conjunction with the accompanying drawings in which:

FIG. 1 generally illustrates a system according to an embodiment of the inventive concept;

FIGS. 2, 3 and 4 are respective block diagrams illustrating certain examples of possible devices that may be incorporated in the system of FIG. 1;

FIGS. 5, 6, 7, 8, 9, 10, 11, 12, 13, 14, 15, 16 and 17 (hereafter, “FIGS. 5-17”) respectively illustrate embodiments of a cursor that may be displayed on a display included in the system of FIG. 1; and

FIGS. 18, 19, 20, 21, 22, 23, and 24 (hereafter, “FIGS. 18-24”) are respective flowcharts summarizing various methods of displaying a cursor on the display that may be performed by the system of FIG. 1.

### DETAILED DESCRIPTION

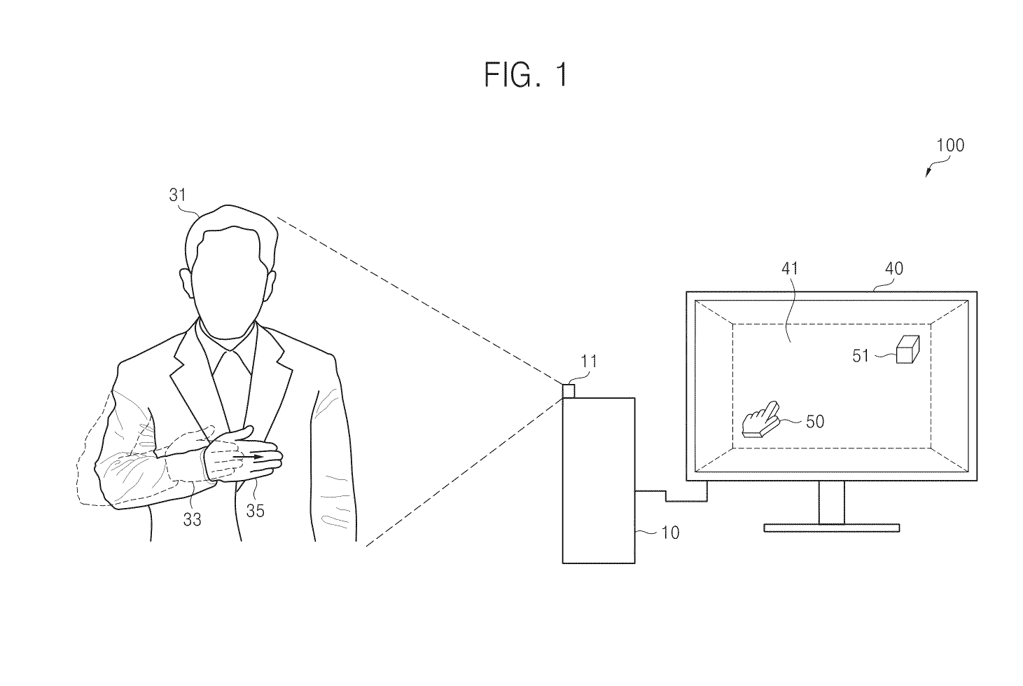

Figure (FIG. 1 is a diagram of a system 100 according to an embodiment of the inventive concept. In the illustrated embodiments that follow, it is assumed that system 100, whatever its particular constitution, may be used as a gesture recognition (or “sensing”) apparatus. The system 100 may take many different forms, such as a smart television (TV), a handheld game console, a personal computer (PC), a smart phone, a tablet PC, etc. The system 100 illustrated in FIG. 1 includes in relevant part; a general “device” 10 and a display 40 associated with the device 10. The device 10 and the display 40 are connected to one another via a hardwired and/or wireless connection. In certain embodiments, the device 10 and display 40 will be integrated within a single apparatus forming system 100.

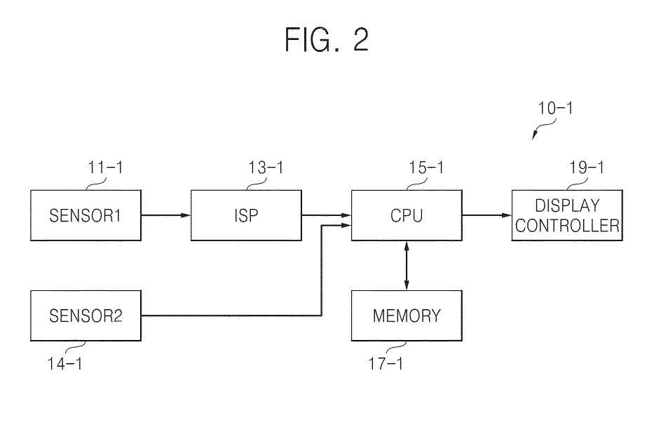

FIG. 1 illustrates a PC example for the system 100 as selected example. The device 10 is assumed to include a sensor 11 capable of sensing a gesture made by a user 31. Of course, the sensor 11 might alternately (or additionally) be included in the display 40. Exemplary structure(s) and corresponding operation(s) of certain devices 10 will be described in some additional detail with reference to FIGS. 2, 3 and 4.

In the context of the illustrated embodiments, the term “gesture” means any action made by a user that elicits a coherent response by the system 100 sufficient to influence the state of a cursor. Some user actions may be large or visually obvious, such as the waving of an arm or moving a hand. Other actions may be small and much less visually obvious, such as blinking or moving one's eye. The “state” of a cursor means any visually recognizable condition associated with the cursor, including as examples, the size of the cursor, its location on a display, its shape, appearance, changing appearance, or movement.

With the system 100 of FIG. 1, the sensor 11 may be depth sensor or a broader sensor (e.g., an optical sensor) including a depth sensor. The depth sensor may be used to “sense” (or detect) a gesture made by the user 31 according to a time-of-flight (TOF) principle. According to one particular embodiment of the inventive concept, the sensor 11 of FIG. 1 is a distance sensor capable of sensing one or more distance(s) between the sensor 11 a “scene” typically including at least one user 31.

A gesture is typically detected as motion (i.e., a change in position or state) of some part of the user's body. The hand of the user 31 will be assumed for purposes of the description that follows. However, those skilled in the art will understand that many different gesture types, gesture indication mechanisms (e.g., a wand or stylist), and different gesture detection technologies may be used in the context of the inventive concept. In the illustrated example of FIG. 1, when the hand of the user 31 moves from a first position 33 to a second position 35 towards the sensor 11, the sensor 11 may recognize the change in position by periodically calculating a distance between the user 31 and the sensor 11. That is, the position change of the user's hand is recognized as a gesture.

According to another embodiment, the sensor 11 may include a motion sensor capable of recognizing the position change of the user's hand as a gesture.

It is further assumed that in the system 100 of FIG. 1, the display 40 provides the user 31 with a 3-dimensional (3D) image. For example, the display 40 may provide the user 31 with a 3D image by using certain conventionally understood stereoscopic techniques. In FIG. 1, the display 40 is assumed to be displaying a 3D image including a 3D object 51 and a 3D cursor 50 to the user 31.

In FIG. 1, the cursor 50 is illustrated as a hand-shaped pointer that indicates cursor position within the display field 41 of the display 40. Of course, any shape and size recognizable to the user 31 as a cursor may be used for this purpose. With this configuration, the sensor 11 is able to sense the gesture of the user 31, and communicate via a corresponding electrical signal (i.e., a “sensing signal”) certain “gesture information” regarding the nature and/or quality of the gesture to the device 10. The device 10 is assumed to be able to process the gesture information provided by the sensor 11, and in response control the operation of the display 40. In other words, the device 10 may adaptively control operation of the display 40 to modify the state of the cursor 50 in the display field 41 in response to a recognized user gesture.

FIG. 2 is a block diagram of a device 10-1 that may be used as the device 10 of FIG. 1. Referring to FIGS. 1 and 2, the device 10-1 includes a first sensor 11-1, an image signal processor (ISP) 13-1, a central processing unit (CPU) 15-1, a memory 17-1, and a display controller 19-1.

The sensor 11 may include the first sensor 11-1. According to the illustrated embodiment of FIG. 2, the first sensor 11-1 may be implemented by using a depth sensor. The first sensor 11-1 may be used to calculate a distance between the first sensor 11-1 and the user 31.

The ISP 13-1 receives a sensing signal from the first sensor 11-1 and periodically calculates the distance between the first sensor 11-1 and the user 31 in response to the sensing signal. The CPU 15-1 may be used to recognize the gesture information associated with the motion of the user's hand using a change in distance calculated by the ISP 13-1, and thereby recognizes the motion as a gesture. The CPU 15-1 may also be used to execute instructions to adaptively control the display of the cursor 50 on the display field 41 in response to the gesture by the user 31.

The memory 17-1 may be used to store the instructions. The memory 17-1 may be implemented using a volatile memory or a non-volatile memory. The volatile memory may be implemented using a dynamic random access memory (DRAM). The non-volatile memory device may be implemented using an electrically erasable programmable read-only memory (EEPROM), flash memory, magnetic RAM (MRAM), spin-transfer torque MRAM (STT-MRAM), conductive bridging RAM (CBRAM), ferroelectric RAM (FeRAM), phase change RAM (PRAM), resistive RAM (RRAM or ReRAM), nanotube RRAM, polymer RAM (PoRAM), a nano floating gate memory (NFGM), holographic memory, molecular electronics memory device, insulator resistance change memory, or the like.

The display controller 19-1 may be used to control the display 40 to adaptively display the cursor 50 on the display field 41 under the control of the CPU 15-1. In certain embodiments, the functionality of the CPU 15-1 and display controller 19-1 may be implemented on a single chip (or “application processor”).

According to an embodiment illustrated in FIG. 2, the sensor 11 may further include a second sensor 14-1, where the second sensor 14-1 is (e.g.,) capable of sensing electromagnetic signals in a given range(s) of frequencies (e.g., visual and/or infrared light). Thus, the second sensor 14-1 may be an optical (or light detecting) sensor.

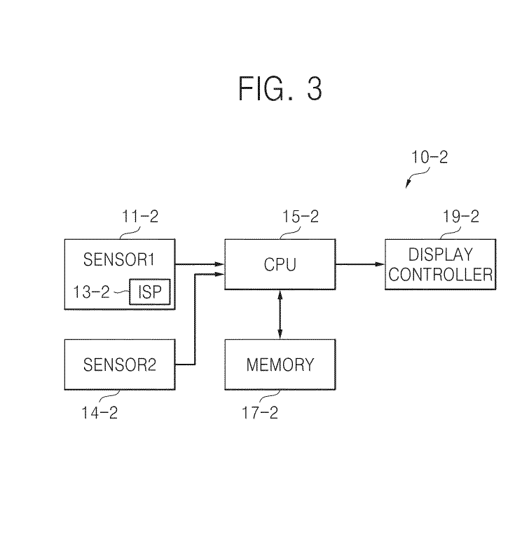

FIG. 3 is a block diagram of a device 10-2 that may be incorporated as another embodiment of the device 10 of FIG. 1. Referring to FIGS. 1 and 3, the device 10-2 includes a first sensor 11-2, an ISP 13-2, a CPU 15-2, a memory 17-2, and a display controller 19-2. Here, the first sensor 11-2 and ISP 13-2 are assumed to be combined in a single chip (or integrated circuit, IC).

The structure and function of the other components of FIG. 3, including 11-2, 13-2, 14-2, 15-2, 17-2, and 19-2, are substantially and respectively the same as those of the components 11-1, 13-1, 14-1, 15-1, 17-1, and 19-1 of FIG. 2. Accordingly, a repetitive description of these components is omitted.

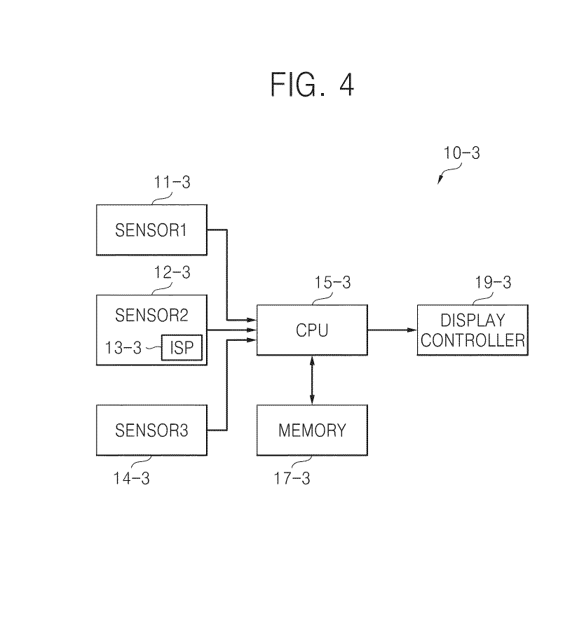

FIG. 4 is a block diagram of a device 10-3 that may be incorporated as still another embodiment of the device 10 of FIG. 1. Referring to FIGS. 1 and 4, the device 10-3 includes first and second sensors 11-3 and 12-3, a CPU 15-3, a memory 17-3, and a display controller 19-3. The sensor 11 may include the first and second sensors 11-3 and 12-3, wherein the second sensor 12-3 and ISP 13-3 are again assumed to be commonly provide by a single chip or IC.

The first sensor 11-3 may be a motion sensor capable of sensing motion by the user 31 as a gesture. The second sensor 12-3 may be used as a distance sensor capable of determining a distance between the second sensor 12-3 and the user 31. And the third sensor 14-3 may be an optical sensor capable of detecting light in the scene including the user 31.

Here again, the respective structure and function of the components 14-3, 15-3, 17-3, and 19-3 of FIG. 4 are substantially the same as those of the components 14-1, 15-1, 17-1, and 19-1 of FIG. 2. Certain methods of displaying a cursor according to embodiments of the inventive concept will now be described in a context that assumes use of the device 10-1 illustrated in FIG. 2.

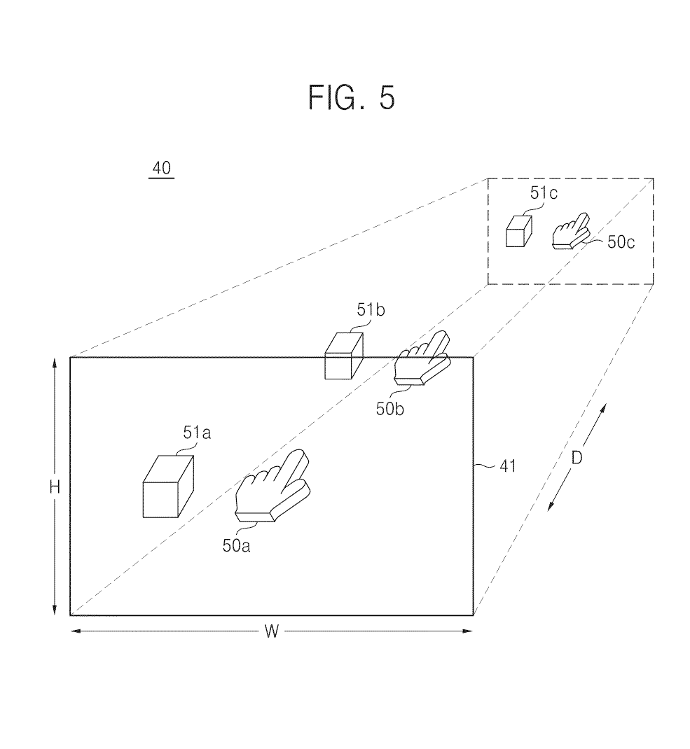

FIG. 5 illustrates an embodiment wherein the display 40 generates the 3D cursor 50 as part of a 3D image displayed on the display field 41 of FIG. 1. Note that the display field 41 generated by the display 40 provides a 3D field of view to the user 31. Hence, the display field 41 may be understood as a 3D field of display having an apparent depth (“D) to the user 31 as well as an apparent width (“W”) and apparent height (“H”).

Referring to FIGS. 1, 2, and 5, the cursor 50 is initially displayed at a first position 50a. Then, the sensor 11 senses a gesture by the user 31. The CPU 15-1 executes instructions to adaptively change the display the cursor 50 in the display field 41 in response to the sensed gesture, as indicated by the gesture information contained in the sensing signal provided by the sensor 11. In the illustrated example of FIG. 5, the forward thrust of the user's gesture (FIG. 1) results in the cursor 50 being re-sized and repositioned in the display field 41.

Thus, as the cursor 50 visually passes from an initial first position 50a through an intermediate second position 50b to a final third position 50c, the size of the “cursor image” decreases. In this context, the term “cursor image” is used to emphasize that a particular image (or object) displayed within the display field is identified by the user 31 as the cursor 50. In the working example, the cursor image is assumed to be a 3D pointing hand shape. The actual choice of cursor image is not important and may be considered a matter of design choice. However, the adaptive modification of the size (or apparent size) of a particular cursor image recognized as the cursor as it is repositioned along a “cursor path” in response to a user gesture is an important aspect of certain embodiments of the inventive concept.

In contrast to the foregoing, were it assumed that the user 31 made an opposite gesture once the cursor 50 arrived at the final position 50c, then the cursor 50 would move from a new initial position 50c to a new final position 50a through the intermediate position 50b with corresponding change (i.e., increases) in the size of the cursor image.

Thus, in response to any reasonable (coherent) gesture made of the user 31, the cursor 50 may be said to be repositioned from a (current) initial position 50a, through a cursor path of variable length including an intermediate position 50b to reach a final position 50c. Such repositioning of the cursor may be done with or without corresponding re-sizing (and/or possibly re-shaping) of the cursor. However, at least the size of the cursor may be adaptively re-determined at intervals along a cursor path defined by a user gesture on the display field 41.

The 3D display field 41 of FIG. 5 is assumed include the object 51 that is moved along with the cursor 50. Thus, the object 51 is moved from position 51a, through position 51b, to position 51c in response to the hand gesture, or more particularly in certain embodiments in response to movement of the cursor 50 in response to the hand gesture. Therefore, in certain embodiments of the inventive concept, the CPU 15-1 may determine the size of the cursor 50 in relation to the size(s) of one or more object(s) 51 being displayed by the display 40. Alternatively, the size of the cursor 50 may be determined without regard to the size(s) of other displayed objects.

The “resizing” of the 3D cursor 50 in conjunction with its movement along a cursor path through the 3D display field 41 in response to a user gesture provides the user 31 with a strong, high-quality feedback response. That is, the manipulation of the cursor 50 by the user 31 generates a visual depth information within the context of the 3D display field generated by the display 40.

Although the display 40 is assumed to be a 3D capable display in the context of the embodiments illustrated in FIGS. 5-17, those skilled in the art will recognize that display 40 may be two-dimension display.

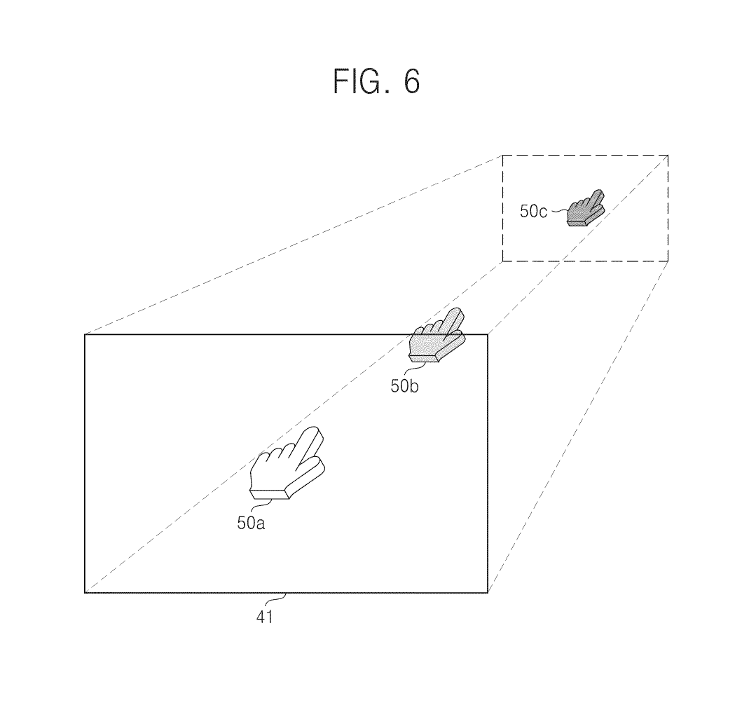

FIG. 6 illustrates another embodiment of the inventive concept wherein the cursor 50 displayed by the display 40 of FIGS. 1 and 2. Referring to FIGS. 1, 2, and 6, the cursor 50 is again repositioned along a cursor path beginning at an initial position 50a, passing through an intermediate position 50b, and stopping at a final position 50c in response to a gesture by the user 31. As before, the cursor 50 is re-sized at interval along the cursor path to yield a moving 3D cursor effect.

However, in the example of FIG. 6, the cursor 50 is also “re-colored” (and/or re-shaded) at interval along the cursor path in response to the user gesture. For example, as the cursor 50 is re-displayed from the initial position 50a through the intermediate position 50b to the final position 50c in response to the user gesture, the color (or shade) of the cursor 50 may be increasingly darkened. For example, the cursor 50 may be displayed as being nominally white at the initial position 50a, relatively light gray at the intermediate second position 50b, and relatively dark gray at the final position 50c. This variable coloring of the cursor 50 may occur in conjunction with the re-sizing of the cursor 50 to further reinforce the illusion of display field depth for a moving 3D cursor in certain embodiments of the inventive concept. In other embodiments, re-coloring (or re-shading) of the cursor 50 may occur without regard to the positioning of the cursor 50.

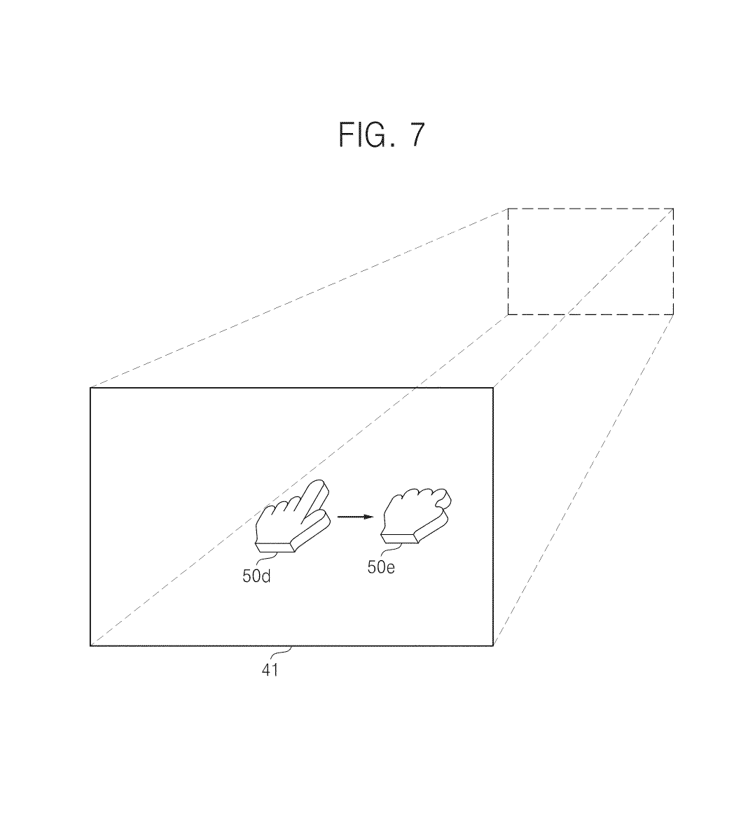

FIG. 7 illustrates another embodiment of the inventive concept wherein the cursor 50 is displayed on the display 40 of FIGS. 1 and 2. Referring to FIGS. 1, 2, and 7, the shape of the cursor 50 is varied in response to the user gesture. For example, in response to a particular user gesture (e.g., clenching extended fingers into a fist), the shape of the cursor 50 may change from a first shape 50d to a second shape 50e.

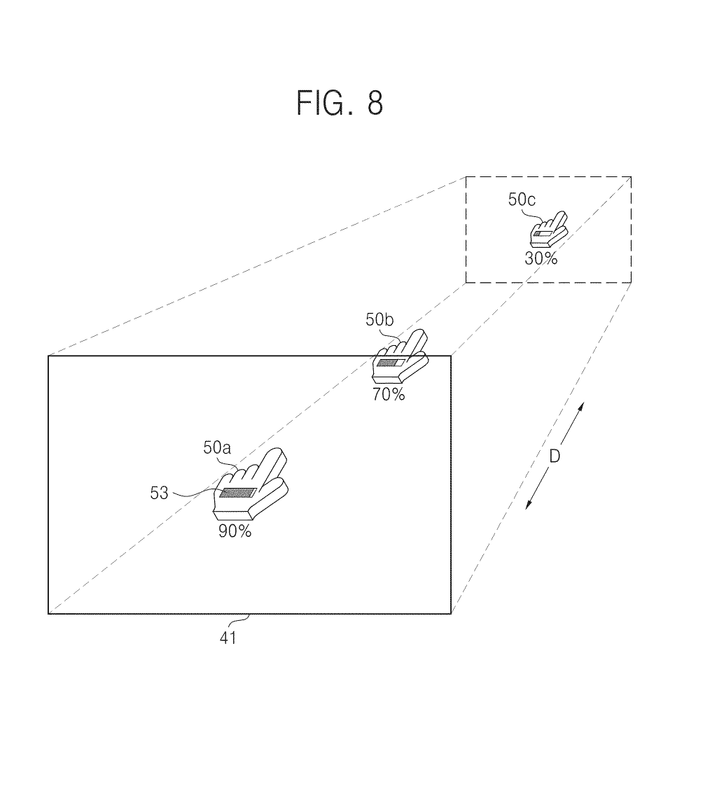

FIG. 8 illustrates still another embodiment of the inventive concept wherein the cursor 50 is displayed on the display 40 of FIGS. 1 and 2. Referring to FIGS. 1, 2, and 8, the cursor 50 is displayed at first, second, and third position 50a, 50b, and 50c along a cursor path for the display field 41. At the respective positions 50a, 50b, or 50c for the cursor 50, the cursor image is modified according to some variable “cursor detail” without completely re-shaping the original cursor 50. Here, a variable bar display 53 is incorporated into the cursor image used to identify the cursor 50. With each newly displayed position for the cursor, the bar display indicates a corresponding value (e.g., respectively, 90%, 70% and 30% for positions 50a, 50b, or 50c). Thus, in certain embodiments of the inventive concept, some displayed cursor detail for the cursor 50 may be correlated with relative the “depth” (“D”) of the cursor within the 3D display field 41. In this manner, the system 100 of FIG. 1 may provide the user 31 with visual position information for the cursor 50 including relative depth information.

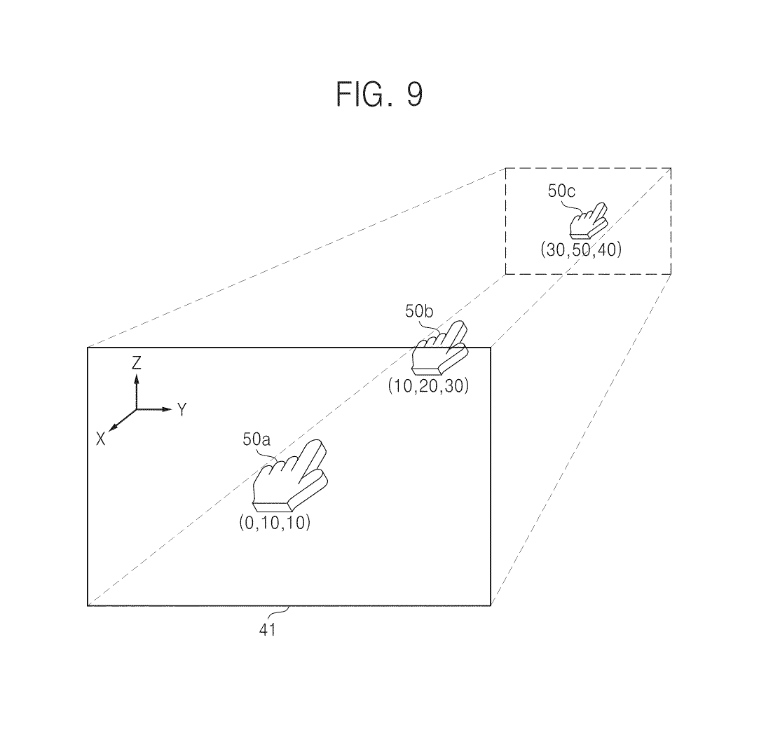

FIG. 9 illustrates yet another embodiment of the inventive concept, where the cursor 50 is displayed on the display 40 of FIGS. 1 and 2. Referring to FIGS. 1, 2, and 9, the first, second, and third position (50a, 50b, and 50c) previously assumed for the cursor 50 are now visually associated with a set of coordinates (e.g., X, Y and Z) for the display field 41. That is, one possible cursor detail that may be used to indicate relative depth information (“Z”) for the cursor 50 is a set of coordinate values that may also be used to indicate relative height information (“Y”) and relative width information (“X”).

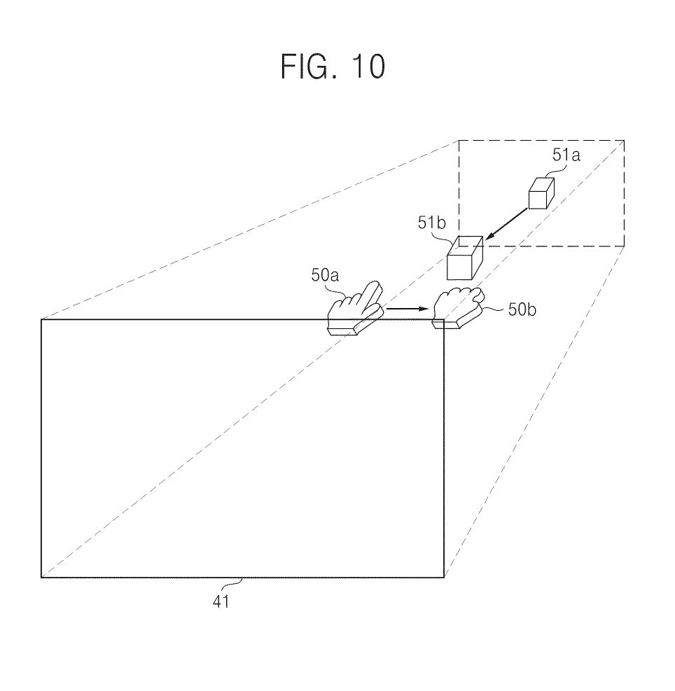

FIG. 10 illustrates another embodiment of the inventive concept wherein the cursor 50 is displayed on the display 40 of FIGS. 1 and 2. Referring to FIGS. 1, 2, and 10, when the object 51 is located at a first position 51a in the display field 41, the cursor 50 may fail to reach the first position 51a of the object 51 in order to manipulate the object 51. Manipulating the object 51 denotes clicking, moving, or translating the object 51 using the cursor 50. According to the illustrated embodiment of FIG. 10, an instruction linked to the object 51 may be performed by clicking on the object 51 with the cursor 50.

Hence, the cursor 50 may be moved from the first position 50a to a second position 50b in response to a user gesture. However, the shape of the cursor 50 is changed by this manipulation movement. That is, the CPU 15-1 may be used to change the shape of the cursor 50 and also the position of the manipulated object 51 from the first position 51a to the second position 51b in response to the manipulation (e.g., clicking) of the object 51 by the cursor 50. In certain embodiments of the inventive concept, respective user gesture(s) will be detected to re-shape the cursor to indicate a particular allowed type of object manipulation as indicated by the cursor image (e.g., grasping, punching, poking, spinning, etc.).

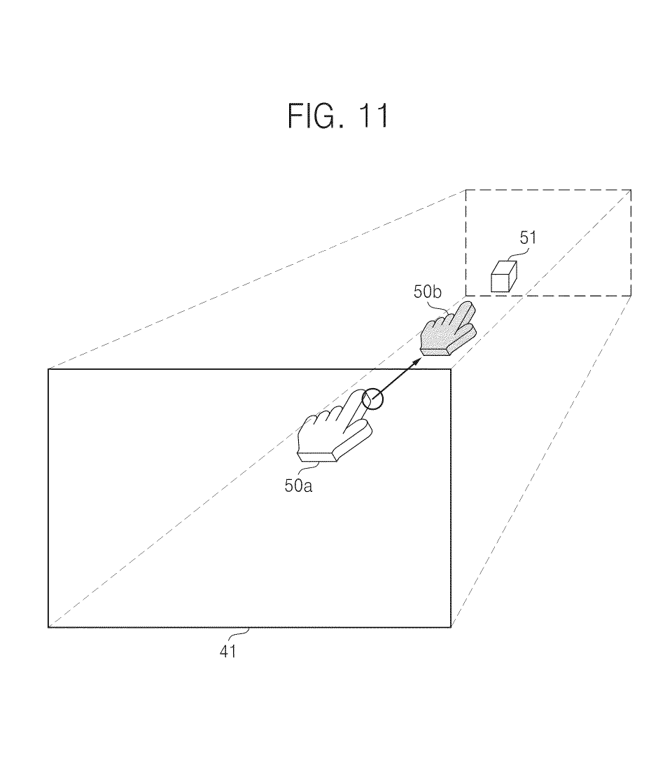

FIG. 11 illustrates another embodiment of the inventive concept wherein the cursor 50 is displayed on the display 40 of FIGS. 1 and 2. Referring to FIGS. 1, 2, and 11, the position of the cursor 50 on the display 40 varies according to user gesture. For example, the cursor 50 may be moved from a first position 50a to a second position 50b. When the cursor 50 is located at the second position 50b, the CPU 15-1 determines whether the cursor 50 is positioned at the object 51. Positioning the cursor 50 at the object 51 means that the cursor 50 is within a distance sufficient to manipulate the object 51.

So, when the cursor 50 is positioned at the object 51, the CPU 15-1 may change the color (or shade) of the cursor 50 to indicate acceptable “object manipulation proximity”. For example, when the cursor 50 is positioned at the object 51, the CPU 15-1 may change the color of the cursor 50 from light to dark, the dark color indicating object manipulation proximity. Thus, the user 31 knows when the object 51 may be manipulated by the cursor 50.

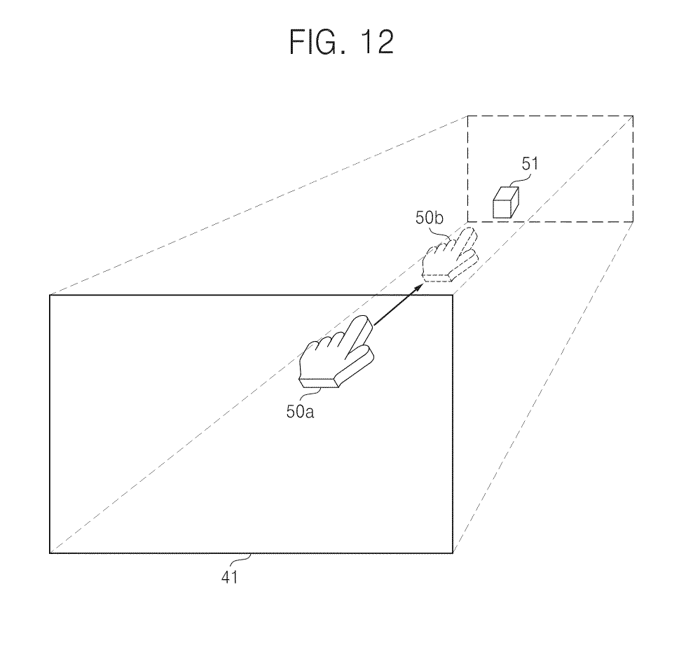

FIG. 12 illustrates another embodiment of the inventive concept wherein the cursor 50 is displayed on the display 40 of FIGS. 1 and 2. Referring to FIGS. 1, 2, and 12, the position of the cursor 50 within the display field 40 will vary the nature of the cursor image during execution of the user gesture (or along a cursor path corresponding to the gesture).

For example, the cursor 50 may be moved from a first position 50a to a second position 50b. When the cursor 50 is located at the second position 50b, the CPU 15-1 determines whether the cursor 50 is positioned at the object 51. When the cursor 50 is positioned at the object 51, the CPU 15-1 highlights the cursor 50. For example, when the cursor 50 is positioned at the object 51, the cursor 50 becomes highlighted. Accordingly, the display 40 may indicate to the user 31 that the object 51 may be manipulated using the cursor 50.

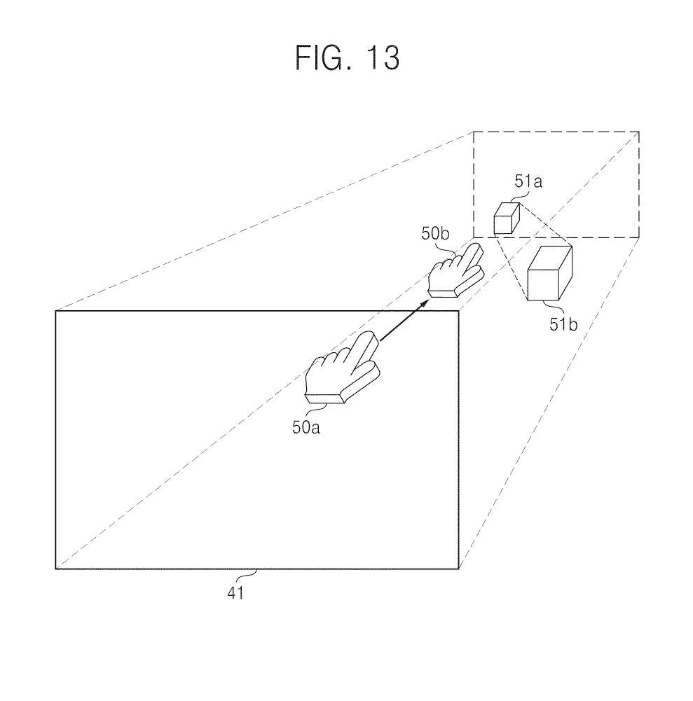

FIG. 13 illustrates another embodiment of the inventive concept wherein the cursor 50 is displayed on the display 40 of FIGS. 1 and 2. Referring to FIGS. 1, 2, and 13, the position and shape of the cursor 50 with the display field 40 are varied in response to a user gesture. For example, the cursor 50 may be changed in its shape while being moved from a first position 50a to a second position 50b. When the cursor 50 is located at the second position 50b, the CPU 15-1 determines whether the cursor 50 is positioned at the object 51. When the cursor 50 is positioned at the object 51, the CPU 15-1 zooms out the object 51. In other words, the CPU 15-1 changes the size of the object 51 from a first size 51a to a second size 51b. Accordingly, the user 31 receive information related to the object 51 according to detail displayed with the larger object 51b.

Alternatively, when it is determined that the cursor 50 is positioned at the object 51, the CPU 15-1 may zoom in the object 51. According to an embodiment, when the cursor 50 is positioned at the object 51 and the shape of the cursor 50 is changed, the object 51 may be zoomed in or out.

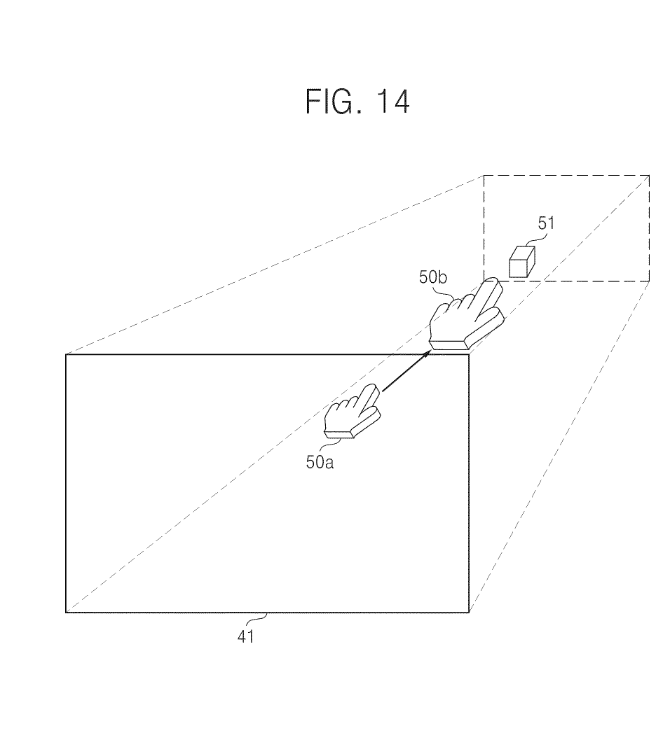

FIG. 14 illustrates another embodiment of the inventive concept wherein the cursor 50 is displayed on the display 40 of FIGS. 1 and 2. Referring to FIGS. 1, 2, and 14, the position of the cursor 50 within the display field 41 is varied in response to a user gesture. For example, the cursor 50 may be moved from a first position 50a to a second position 50b. When the cursor 50 is located at the second position 50b, the CPU 15-1 determines whether the cursor 50 is positioned at the object 51. When the cursor 50 is positioned at the object 51, the CPU 15-1 re-sizes the cursor 50.

In other words, the cursor 50 has a larger size when the cursor 50 is located at the second position 50b than when the cursor 50 is located at the first position 50a. Accordingly, the display 40 may inform the user 31 that the object 51 can be manipulated by using the cursor 50.

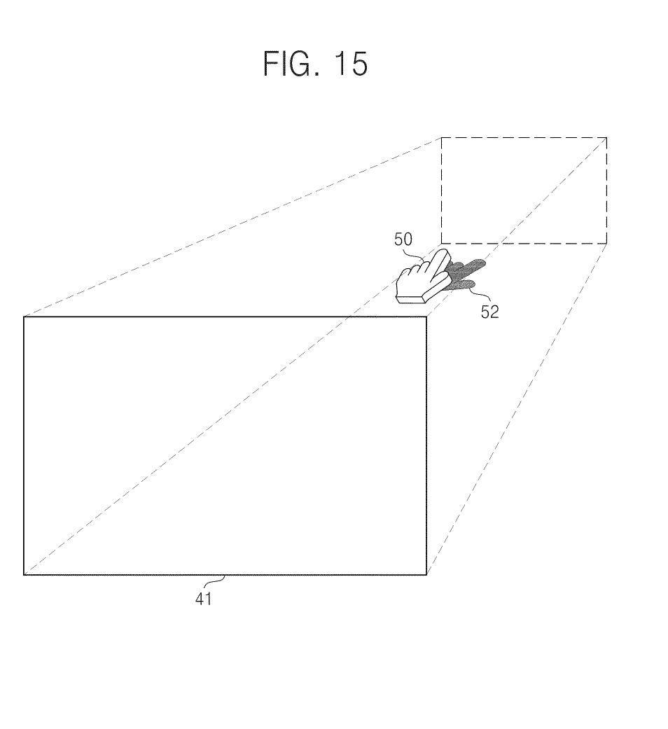

FIG. 15 illustrates another embodiment of the inventive concept wherein the cursor 50 is displayed on the display 40 of FIGS. 1 and 2. Referring to FIGS. 1, 2, and 15, when the device 10-1 includes the second sensor 14-1, the second sensor 14-1 may sense surrounding light. According to a sensing signal output from the second sensor 14-1, the CPU 15-1 may determine the direction of the surrounding light. The CPU 15-1 may control the display controller 19-1 to display a shadow 52 of the cursor 50 on the display 40 according to the direction of the surrounding light. According to an embodiment, the shadow 52 of the cursor 50 may be determined depending on the direction of light displayed on the display 40.

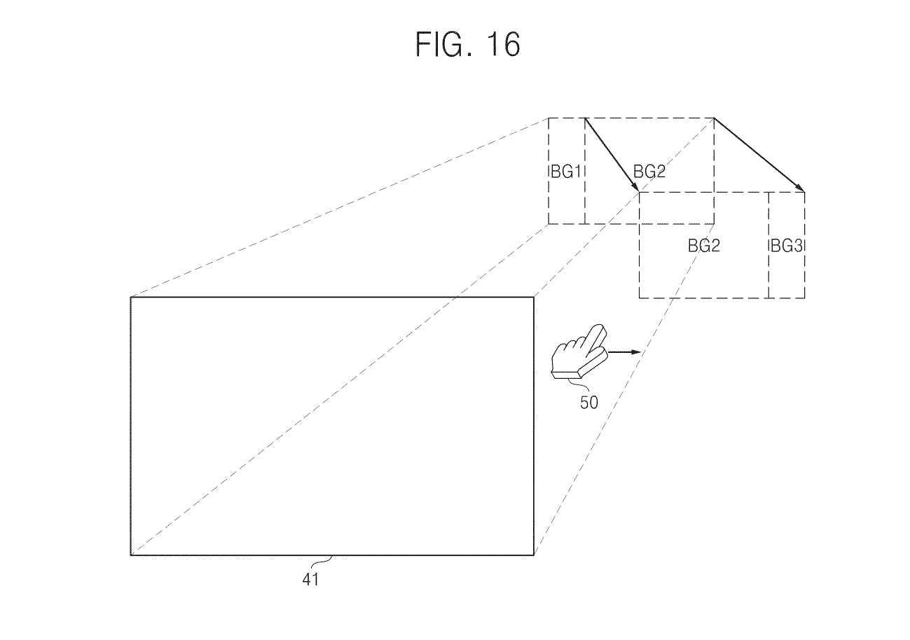

FIG. 16 illustrates another embodiment of the inventive concept wherein the cursor 50 is displayed on the display 40 of FIGS. 1 and 2. Referring to FIGS. 1, 2, and 16, one of a plurality of first backgrounds BG1 and BG2 may be selectively displayed in the display field 41 in response to a user gesture. For example, when the position of the cursor 50 crosses an edge of the display field 41, the CPU 15-1 may change (or scroll) the combination of first and second backgrounds (BG1 and BG2) into a combination of second and third backgrounds (BG2 and BG3).

Accordingly, the user 31 may selective control the display of backgrounds using a gesture. In this manner, the visual impression of gesture-induced “movement” within the field display 41 may be created. In certain embodiments of the inventive concept, the shape of the cursor 50 is be changed as it crosses over the edge of the display field 41 in response to a user gesture.

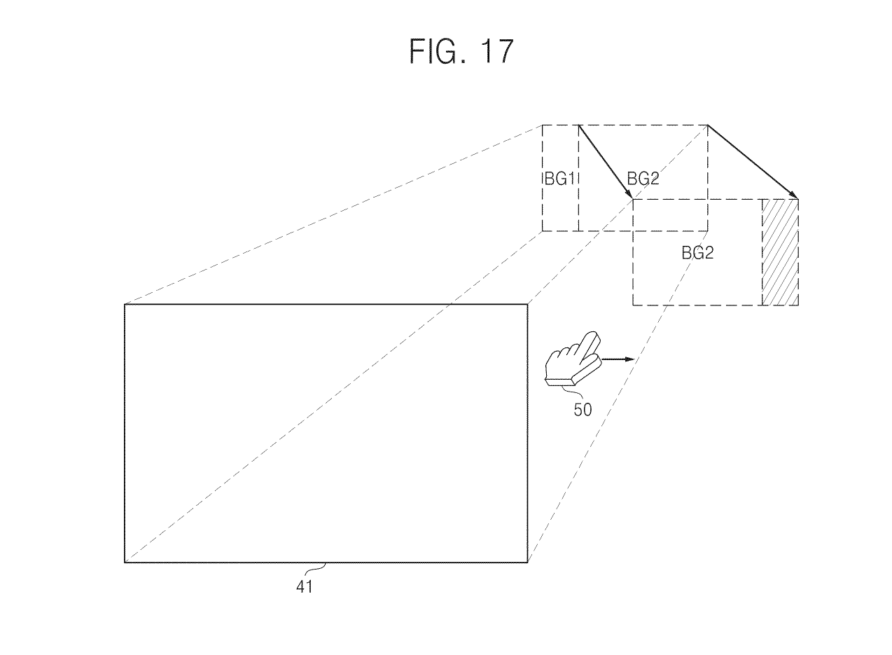

FIG. 17 illustrates another embodiment of the inventive concept wherein the cursor 50 is displayed on the display 40 of FIGS. 1 and 2. Referring to FIGS. 1, 2, and 17, a combination of backgrounds BG1 and BG2 is currently displayed in the display field 41 may be varied according to user gesture.

For example, when the position of the cursor 50 crosses over an edge of the display field 41, the CPU 15-1 may control the display controller 19-1 to display a black region proximate the edge of the background BG1 on the display field 41. Accordingly, the user 31 understands that there are is more background to be displayed in the direction indicted by the gesture (i.e., to the right of background BG2).

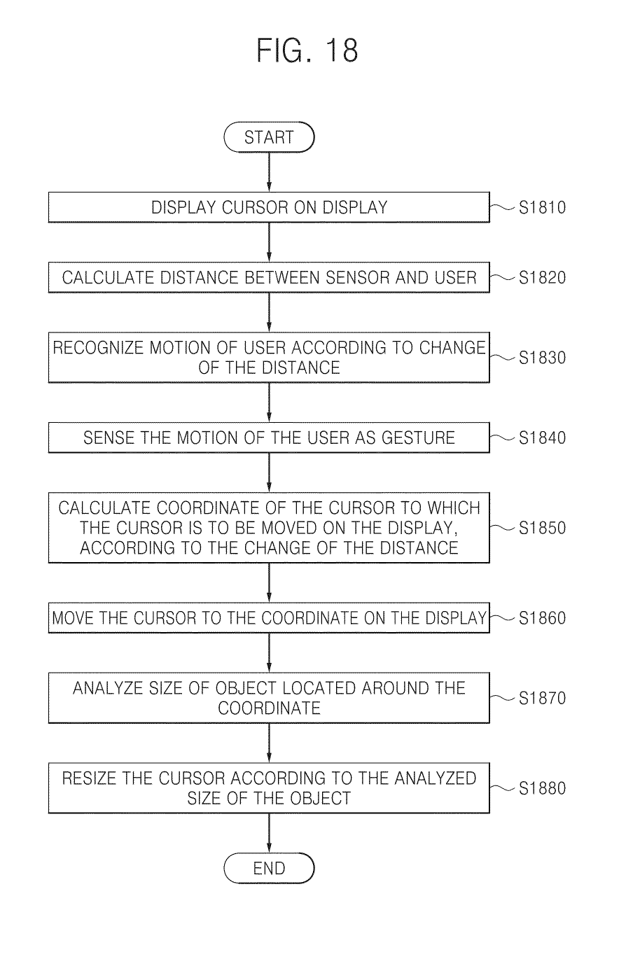

FIG. 18 is a flowchart summarizing a method of displaying the cursor 50 on the display 40 of FIG. 1 according to an embodiment of the inventive concept. Referring to FIGS. 1, 2, 5, and 18, the CPU 15-1 controls the display controller 19-1 to display the cursor 50 on the display 40, in operation S1810. In operation S1820, the ISP 13-1 periodically calculates a distance between the first sensor 11-1 and the user 31 by using a sensing signal output by the first sensor 11-1.

In operation S1830, the CPU 15-1 recognizes a motion of the user 31 by using a distance change calculated by the ISP 13-1. The distance change denotes a difference between distances between the first sensor 11-1 and the user 31 calculated at arbitrary points of time. In operation S1840, the CPU 15-1 senses the motion of the user 31 as a gesture.

In operation S1850, the CPU 15-1 calculates a coordinate of the cursor 50 to which the cursor 50 is to be moved on the display 40, according to the distance change. In operation S1860, the CPU 15-1 controls the display controller 19-1 to move the cursor 50 to the coordinate on the display 40. The display 40 moves the cursor 50 to the coordinate and displays the moved cursor 50, under the control of the display controller 19-1.

In operation S1870, the CPU 15-1 analyzes the size of the object 51 located around the coordinate. The CPU 15-1 analyzes the size of the object 51 at each of the positions 51a, 51b, and 51c of the object 51. In operation S1880, the CPU 15-1 controls the display controller 19-1 to re-size the cursor 50 according to the analyzed sizes of the object 51. The display 40 re-sizes the cursor 50 and displays the re-sized cursor 50, under the control of the display controller 19-1.

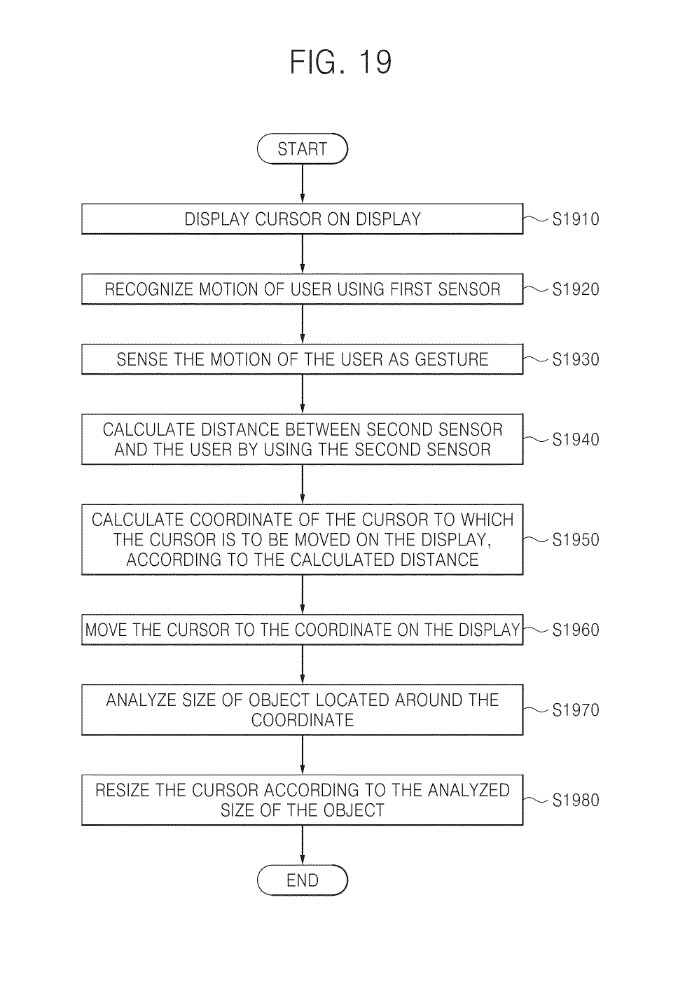

FIG. 19 is a flowchart summarizing a method of displaying the cursor 50 on the display 40 of FIG. 1 according to another embodiment of the inventive concept. Referring to FIGS. 1, 4, 5, and 19, the CPU 15-3 controls the display controller 19-3 to display the cursor 50 on the display 40, in operation S1910. In operation S1920, the motion of the user 31 may be recognized using the first sensor 11-3. The first sensor 11-3 or the CPU 15-3 may recognize the motion of the user 31.

In operation S1930, the CPU 15-3 senses the motion of the user 31 as a gesture. In operation S1940, the ISP 13-3 calculates a distance between the second sensor 12-3 and the user 31 by using a sensing signal output by the second sensor 12-3.

In operation S1950, the CPU 15-3 calculates a coordinate of the cursor 50 to which the cursor 50 is to be moved on the display 40, according to the calculated distance. In operation S1960, the CPU 15-3 controls the display controller 19-3 to move the cursor 50 to the coordinate on the display 40. The display 40 moves the cursor 50 to the coordinate and displays the moved cursor 50, under the control of the display controller 19-3.

In operation S1970, the CPU 15-3 analyzes the size of the object 51 located around the coordinate. The CPU 15-3 analyzes the size of the object 51 at each of the positions 51a, 51b, and 51c of the object 51. In operation S1980, the CPU 15-3 controls the display controller 19-3 to re-size the cursor 50 according to the analyzed sizes of the object 51. The display 40 re-sizes the cursor 50 and displays the re-sized cursor 50, under the control of the display controller 19-3.

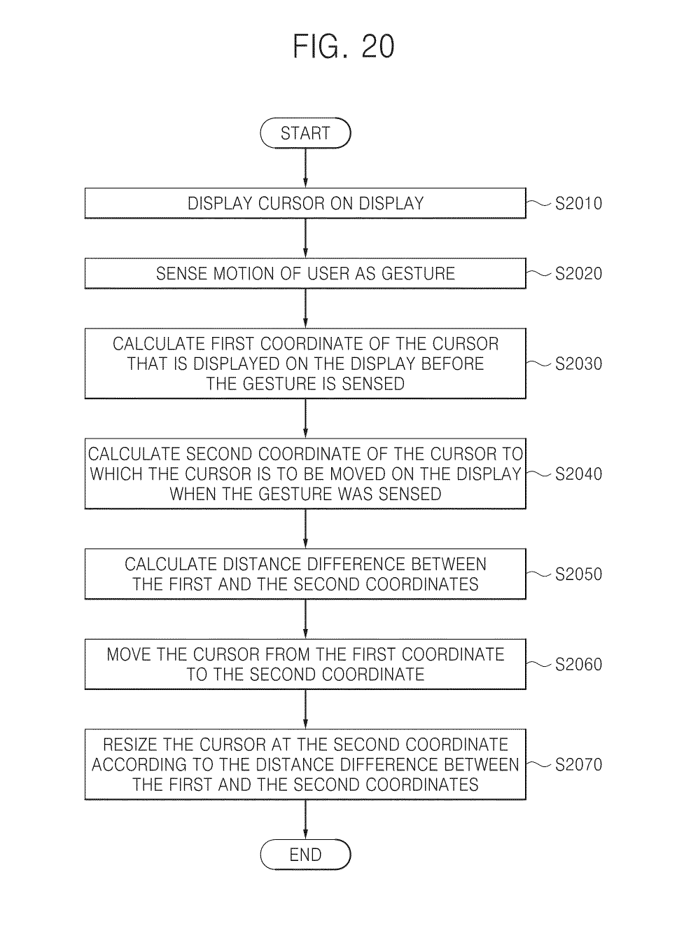

FIG. 20 is a flowchart summarizing a method of displaying the cursor 50 on the display 40 of FIG. 1 according to another embodiment of the inventive concept. Referring to FIGS. 1, 2, 5, and 20, the CPU 15-1 controls the display controller 19-1 to display the cursor 50 on the display 40, in operation S2010.

In operation S2020, the CPU 15-1 senses the motion of the user 31 as a gesture. The motion of the user 31 may be recognized using the first sensor 11-1, namely, a depth sensor 11-1, of FIG. 2. According to an embodiment, the motion of the user 31 may be sensed using the first sensor 11-3, namely, a motion sensor 11-3, of FIG. 4.

In operation S2030, the CPU 15-1 calculates a first coordinate of the cursor 50 that is displayed on the display 40 before the gesture is sensed. In operation S2040, the CPU 15-1 calculates a second coordinate of the cursor 50 to which the cursor 50 is to be moved on the display 40 when the gesture was sensed. n operation S2050, the CPU 15-1 calculates a distance difference between the first and second coordinates.

In operation S2060, the CPU 15-1 controls the display controller 19-1 to move the cursor 50 from the first coordinate to the second coordinate on the display 40. The display 40 moves the cursor 50 to the second coordinate and displays the moved cursor 50, under the control of the display controller 19-1. In operation S2070, the CPU 15-1 controls the display controller 19-1 to re-size the cursor 50 according to the distance difference between the first and second coordinates. The display 40 re-sizes the cursor 50 at the second coordinate and displays the re-sized cursor 50, under the control of the display controller 19-1.

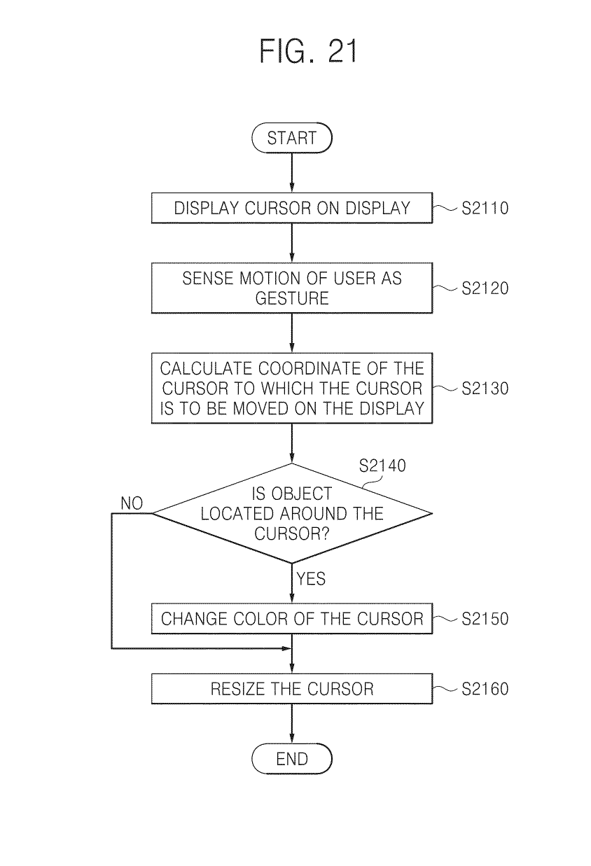

FIG. 21 is a flowchart summarizing a method of displaying the cursor 50 on the display 40 of FIG. 1 according to another embodiment of the inventive concept. Referring to FIGS. 1, 2, 11, and 21, the CPU 15-1 controls the display controller 19-1 to display the cursor 50 on the display 40, in operation S2110.

In operation S2120, the CPU 15-1 senses the motion of the user 31 as a gesture. The motion of the user 31 may be recognized using the depth sensor 11-1 of FIG. 2. According to an embodiment, the motion of the user 31 may be sensed using the motion sensor 11-3 of FIG. 4.

In operation S2130, the CPU 15-1 calculates a coordinate of the cursor 50 to which the cursor 50 is to be moved on the display 40. In operation S2140, the CPU 15-1 determines whether the cursor 50 is positioned at the object 51. When the cursor 50 is positioned at the object 51, the CPU 15-1 changes the color of the cursor 50, in S2150. For example, when the cursor 50 is positioned at the object 51, the CPU 15-1 may change the color of the cursor 50 from white to black. In operation S2160, the CPU 15-1 re-sizes the cursor 50. According to an embodiment, the resizing of the cursor 50 and a color change of the cursor 50 may occur simultaneously, or the resizing of the cursor 50 may occur prior to the color change of the cursor 50.

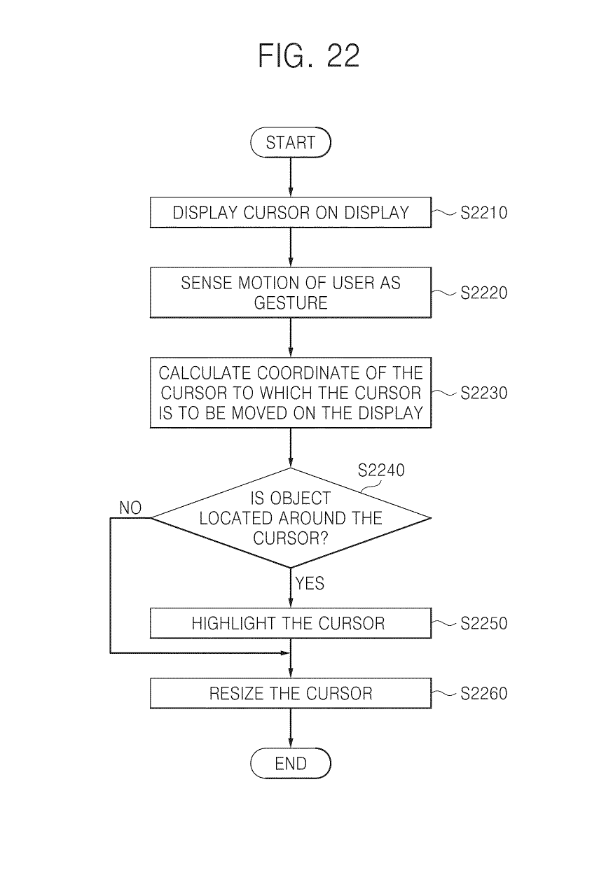

FIG. 22 is a flowchart summarizing a method of displaying the cursor 50 on the display 40 of FIG. 1 according to another embodiment of the inventive concept. Referring to FIGS. 1, 2, 12, and 22, the CPU 15-1 controls the display controller 19-1 to display the cursor 50 on the display 40, in operation S2210.

In operation S2220, the CPU 15-1 senses the motion of the user 31 as a gesture. The motion of the user 31 may be recognized using the depth sensor 11-1 of FIG. 2. According to an embodiment, the motion of the user 31 may be sensed using the motion sensor 11-3 of FIG. 4.

In operation S2230, the CPU 15-1 calculates a coordinate of the cursor 50 to which the cursor 50 is to be moved on the display 40. In operation S2240, the CPU 15-1 determines whether the cursor 50 is positioned at the object 51. When the cursor 50 is positioned at the object 51, the CPU 15-1 highlights the cursor 50, in operation S2250. In operation S2260, the CPU 15-1 re-sizes the cursor 50. According to an embodiment, the resizing of the cursor 50 and the highlighting of the cursor 50 may occur simultaneously, or the resizing of the cursor 50 may occur prior to the highlighting of the cursor 50.

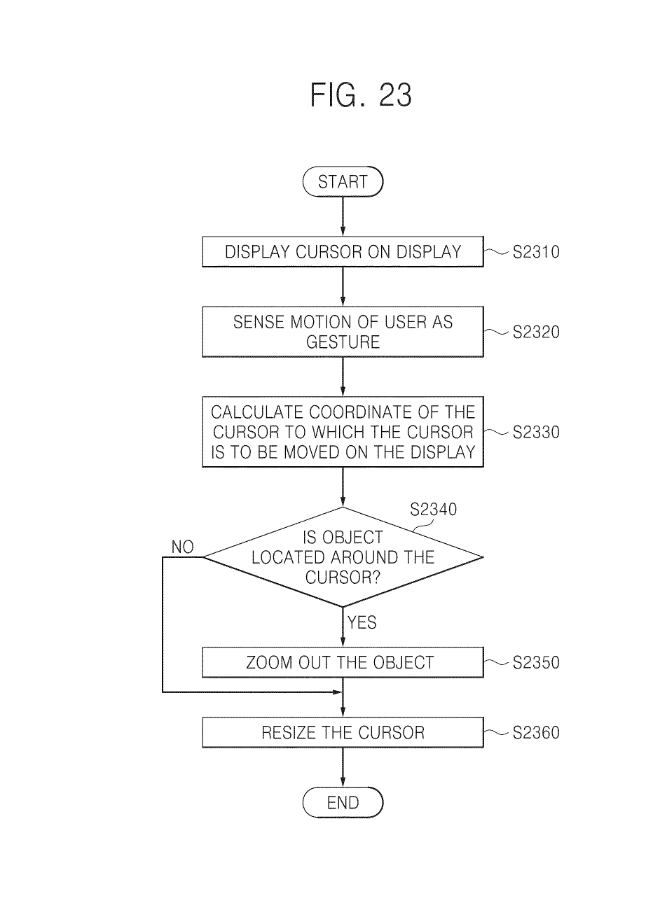

FIG. 23 is a flowchart summarizing a method of displaying the cursor 50 on the display 40 of FIG. 1 according to another embodiment of the inventive concept. Referring to FIGS. 1, 2, 13, and 23, the CPU 15-1 controls the display controller 19-1 to display the cursor 50 on the display 40, in operation S2310.

In operation S2320, the CPU 15-1 senses the motion of the user 31 as a gesture. The motion of the user 31 may be recognized using the depth sensor 11-1 of FIG. 2. According to an embodiment, the motion of the user 31 may be sensed using the motion sensor 11-3 of FIG. 4.

In operation S2330, the CPU 15-1 calculates a coordinate of the cursor 50 to which the cursor 50 is to be moved on the display 40. In operation S2340, the CPU 15-1 determines whether the cursor 50 is positioned at the object 51. When the cursor 50 is positioned at the object 51, the CPU 15-1 zooms out the object 51, in operation S2350. In other words, the CPU 15-1 changes the size of the object 51 from the first size 51a to the second size 51b. In operation S2360, the CPU 15-1 re-sizes the cursor 50. According to an embodiment, the resizing of the cursor 50 and the zooming-out of the cursor 51 may occur simultaneously, or the resizing of the cursor 50 may occur prior to the zooming-out of the cursor 51.

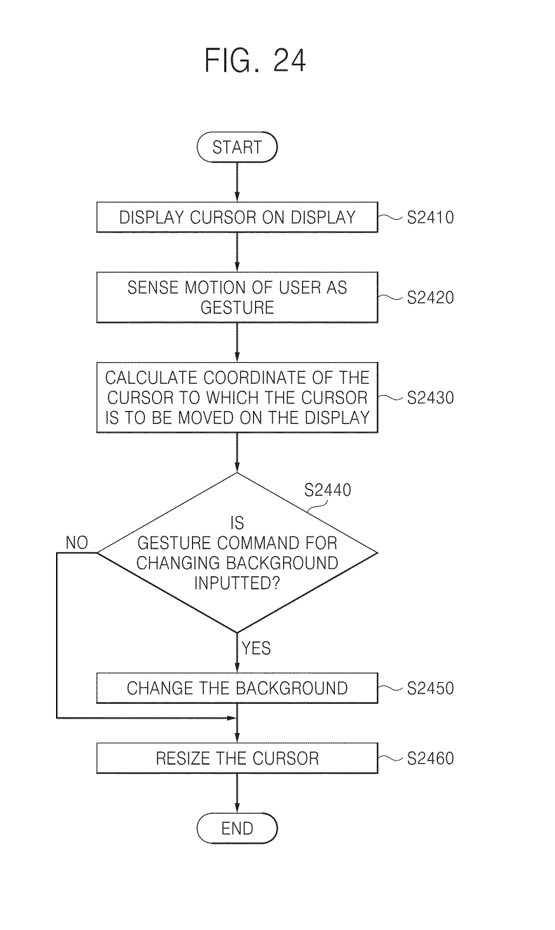

FIG. 24 is a flowchart summarizing a method of displaying the cursor 50 on the display 40 of FIG. 1 according to another embodiment of the inventive concept. Referring to FIGS. 1, 2, 16, and 24, the CPU 15-1 controls the display controller 19-1 to display the cursor 50 on the display 40, in operation S2410.

In operation S2420, the CPU 15-1 senses the motion of the user 31 as a gesture. The motion of the user 31 may be recognized using the depth sensor 11-1 of FIG. 2. According to an embodiment, the motion of the user 31 may be sensed using the motion sensor 11-3 of FIG. 4. In operation S2430, the CPU 15-1 calculates a coordinate of the cursor 50 to which the cursor 50 is to be moved on the display 40. In operation S2440, the CPU 15-1 determines whether the cursor 50 is positioned at the object 51.

When the cursor 50 is positioned at the object 51, the backgrounds BG1 and BG2 displayed on the display 40 may vary according to a gesture of the user 31. For example, when the position of the cursor 50 deviates from the edge of the display 40, the CPU 15-1 may change the first backgrounds BG1 and BG2 to the second backgrounds BG2 and BG3. When the shape of the cursor 50 is changed on the edge of the display 40 due to a gesture of the user 31, the CPU 15-1 may change the first backgrounds BG1 and BG2 to the second backgrounds BG2 and BG3. In operation S2460, the CPU 15-1 re-sizes the cursor 50. According to an embodiment, the resizing of the cursor 50 and the background change of the cursor 50 may occur simultaneously, or the resizing of the cursor 50 may occur prior to the background change of the cursor 50.

Several of the foregoing embodiments of the inventive concept may be combined with one another in a variety of combinations. For example, at least one of resizing, shape change, color change, and shadow production of the cursor 50 may be combined together and performed by the display 40.

In cursor displaying methods according to various embodiments of the inventive concept and systems performing the cursor displaying methods, a cursor may be adaptively displayed on a display field in response to a user gesture.

While the inventive concept has been particularly shown and described with reference to embodiments thereof, it will be understood that various changes in form and details may be made therein without departing from the scope of the following claims.

What is claimed is:

1. A cursor displaying method comprising:
displaying a cursor in a display field of a display;
sensing a user gesture with a sensor;
generating a sensing signal including gesture information derived from the sensed user gesture; and
controlling the display in response to the sensing signal to re-size the cursor in the display field at least once along a cursor path defined by the gesture information while repositioning the cursor from an initial position to a final position in the display field.

2. The method of claim 1, wherein the sensing the user gesture comprises:
periodically calculating a distance between the user and the sensor using a depth sensor;
recognizing a user action at least in part according to a change in the distance; and
sensing the user action as the user gesture.

3. The method of claim 2, wherein the re-size of the cursor in the display field comprises:
upon sensing the user gesture, determining a final position to which the cursor will be moved in accordance with the change in the distance and in view of an initial position of the cursor when the user gesture is sensed;
moving the cursor along the cursor path connecting the initial position and the final position; and
resizing the cursor at least once while moving the cursor along the cursor path.

4. The method of claim 2, wherein the re-size of the cursor in the display field comprises:
calculating a first coordinate for an initial position of the cursor when the user gesture is sensed;
calculating a second coordinate for a final position to which the cursor will be moved in accordance with the change in direction;
calculating a distance difference between the first and second coordinates;
moving the cursor from the first coordinate to the second coordinate; and
resizing the cursor at the second coordinate relative to a size of the cursor at the first position.

5. The method of claim 1, further comprising:
changing a first color of the cursor at the initial position to a second color different from the first color at a position along the cursor path other than the initial position.

6. The method of claim 1, further comprising:
changing a first shade of the cursor at the initial position to a second shade different from the first shade at a position along the cursor path other than the initial position.

7. The method of claim 1, further comprising:
changing a first shape of the cursor at the initial position to a second shape different from the first shape at a position along the cursor path other than the initial position.

8. The method of claim 1, wherein the cursor displayed in the display field includes cursor detail indicating to the user a relative position of the cursor in the display field.

9. The method of claim 8, wherein the cursor detail is percentage bar display.

10. The method of claim 8, wherein the cursor detail is a set of three-dimensional (3D) coordinates.

11. The method of claim 1, further comprising:
displaying object in the display field; and
manipulating at least one of a position, a shape, and a color of the object in response to sensing the user gesture.

12. The method of claim 11, further comprising:
repositioning the object in the display field in response to repositioning the cursor in the display field.

13. The method of claim 11, further comprising:
changing at least one of a shape and a color of the cursor as it is repositioned to come within an object manipulation proximity of the object in the display field.

14. The method of claim 11, further comprising:
enabling one of a set of manipulations for the object when the cursor is repositioned to come within the object manipulation proximity.

15. The method of claim 11, further comprising:
zooming in or zooming out the object in the display field after moving the cursor within an object manipulation proximity of the object in the display field.

16. The method of claim 13, further comprising:
sensing light surrounding the user using an optical sensor; and
displaying a shadow relative to the cursor in the display field in accordance with a direction of the user gesture and in accordance with the light surrounding the user.

17. The method of claim 1, further comprising:
displaying a new background in the display field when the user gesture causes the cursor to be repositioned beyond an edge of an old background for the display field upon sensing the user gesture.

18. The method of claim 1, wherein the new background includes a black field indicating an outer edge of the new background.

19. The method of claim 1, wherein the sensing the user gesture comprises:
recognizing motion by the user by using a first sensor; and
sensing the motion by the user as the user gesture.

20. The method of claim 19, wherein the re-size of the cursor comprises:
determining a distance between the user and a second sensor using the second sensor upon sensing the user gesture;
calculating a new coordinate for the cursor in the display field to which the cursor will be moved according to the calculated distance;
moving the cursor to the new coordinate;
analyzing a size of an object displayed proximate the new coordinate; and
resizing the cursor in accordance with the size of the object.

21. The method of claim 20, wherein the first sensor is a motion sensor and the second sensor is a depth sensor.

22. A system comprising:
a three-dimensional (3D) display that displays a cursor in a 3D display field;
a sensor that senses a user gesture and provides a corresponding sensing signal; and
a central processing unit (CPU) that controls the 3D display to re-size the cursor according to the sensing signal as the cursor is repositioned in the 3D display field in response to the user gesture.

23. The system of claim 22, wherein the sensor comprises a depth sensor that calculates a distance between the user and the sensor.

24. The system of claim 23, wherein the sensor further comprises a motion sensor that detects a motion by the user as the user gesture.

25. The system of claim 24, wherein the sensor further comprises a light sensor that senses light surrounding the user.
